(19) United States
(12) Patent Application Publication
(10) Pub. No.: US 2002/0032295 A1
(43) Pub. Date: Mar. 14, 2002

(54) BIAXIALLY ORIENTED POLYPROPYLENE FILM STRUCTURE HAVING IMPROVED MECHANICAL AND BARRIER PROPERTIES

(76) Inventors: HERBERT PEIFFER, MAINZ (DE); THOMAS DRIES, SCHWABENHEIM (DE); URSULA MURSCHALL, NIERSTEIN (DE); GUNTER SCHLOEGL, KELKHEIM (DE)

Correspondence Address: CONNOLLY AND HUTZ, P.O. BOX 2207, WILMINGTON, DE, 19899

(21) Appl. No.: 08/312,295

(22) Filed: Sep. 26, 1994

(30) Foreign Application Priority Data
Sep. 27, 1993 (DE) P 43 32 835.0
Nov. 2, 1993 (DE) P 43 37 250.3

(51) Int. Cl. C08F 210/00

(52) U.S. Cl. 526/348.1; 525/333.8; 428/212; 428/215; 428/216; 428/220; 428/327; 428/516

(57) ABSTRACT

A single-ply or laminar biaxially oriented polypropylene film structure is described. The n-hexane-insoluble fraction of the film has a chain isotaxy index, measured by means of ¹³C-NMR spectroscopy, of at least 95%. The base ply of the laminar structure (or the single ply of the single-ply structure) contains essentially no hydrocarbon resin or low molecular weight resin. The modulus of elasticity of the film structure in the longitudinal direction is greater than 2,500 N/mm². The modulus of elasticity of the film structure in the transverse direction is greater than 4,00 N/mm².

A process for the production of the polypropylene film structure and the use thereof are also described.

### FIELD OF THE INVENTION

This invention relates to a polypropylene film or film structure (single-ply or laminar) having improved barrier properties with regard to the passage of water vapor and oxygen and improved mechanical properties.

### DESCRIPTION OF THE PRIOR ART

The improvement in the mechanical properties of films, in particular of films for the packaging sector, has recently become more important. For cost reasons and environmental reasons, the packaging industry requires increasingly thin films with unchanged running characteristics in machines and unchanged or improved barrier properties, in particular with regard to the passage of water vapor and oxygen.

However, thinner films have disproportionately poorer rigidity in the machine direction and hence substantially poorer running characteristics in machines, in particular in today's high-speed wrapping machines. Furthermore, the barrier properties, too, decline disproportionately with the reduction in the film thickness. Owing to the poorer barrier properties of thin films, the protective effect of the film to prevent spoiling of the contents is greatly limited.

The rigidity (R) of the film is proportional to the modulus of elasticity (E) and to the third power of the thickness (d) [R=E·d³]. In the case of relatively thin films, it is therefore only possible to compensate the loss of rigidity via the modulus of elasticity of the film.

Increasing the modulus of elasticity (E modulus) in the machine direction has long been the subject of intensive efforts, because this mechanical property is directly related to the suitability for use and hence directly determines the processing behavior.

As described in the product surveys from the companies Mobil Plastics Europe and Hoechst AG, for example, the tensile modulus of elasticity (DIN 53 457, ASTM 882) of conventional boPP films in the longitudinal direction is between 2,000 and 2,200 N/mm², regardless of the thickness.

The water vapor transmission (WVT) and oxygen transmission (OT) of boPP films decrease with increasing film thickness. In the conventional thickness range of boPP films (4 to 100 μm), there is, for example, approximately a hyperbolic relationship (WVT·d=const.) between the water vapor transmission (WVT) and the thickness (d). The constant essentially depends on the raw material composition and the stretching conditions. For boPP packaging films according to the prior art, the constant has a value of about: const.=28 g·μm/m²·d. The water vapor transmission was measured here according to DIN 53 122. The stated product surveys reveal that, for example, the water vapor transmission of a 25 μm thick boPP film is 1.1 g/M² d.

It is known that, in the case of boPP films, the modulus of elasticity in the machine direction can be increased either by means of process engineering or by means of raw material modifications or a combination of the two possibilities.

A possible method for the production of high-strength polypropylene films is a three-stage or multistage stretching process, as described, for example, in EP-B-0 116 457. However, such a production process has the disadvantage that it requires an additional apparatus for subsequent longitudinal stretching and is therefore very expensive. Moreover, it is very susceptible to breakdowns in the course of production, for example tears in the film.

Furthermore, such subsequently longitudinally stretched films exhibit longitudinal shrinkage which is substantially higher compared with only biaxially stretched films and which as a rule prevents the films from withstanding thermal drying, as is still usual in some cases, for example after application of adhesive materials, without undesirable shrink folds.

The modification of the raw materials used for the production of high-strength polypropylene films with various hydrocarbon resins is described, for example, in U.S. Pat. No. 3,937,762. Such modification of raw materials permits the production of polypropylene films whose mechanical strength in the longitudinal direction is substantially improved compared with films of unmodified raw materials but does not reach the values of subsequently longitudinally stretched films, and shrinkage in the longitudinal direction is likewise relatively high.

EP-A-0 406 642 describes a boPP film having high mechanical strength. The high modulus of elasticity in the longitudinal direction is achieved if the base ply contains 5 to 30% by weight of a hydrocarbon resin and 0.01 to 1.0% by weight of a nucleating agent. This patent publication provides no information about barrier properties. In the Examples, a resin concentration of 20% by weight is mentioned.

Such high resin concentrations lead to problems in film production. In particular, deposits occur after a short time on the screw of the plasticating extruder and on the rolls of the longitudinal stretching unit. Furthermore, the addition of nucleating agents in the stated concentration leads to optical film defects in the form of so-called “specks” and “bubbles”, which of course are extremely undesirable. In addition, the regenerated material from such films can no longer be used owing to the tendency to agglomerate in the film production process. Furthermore, the stretching ratios stated in Examples 3 to 6 of EP-A-0 406 642 cannot be realized on any production machine at the conventional speeds with the homopolymer described there. Film constantly tears, particularly during transverse stretching.

Outstanding mechanical properties can be achieved by the combination of the addition of a resin to the raw material used with a subsequent longitudinal stretching process. A corresponding procedure is described in EP-A-0 079 520; moduli of elasticity in the longitudinal direction of 4,000 to 6,000 N/mm² are achieved. However, this process, too, has the disadvantage that an expensive subsequent longitudinal stretching process susceptible to faults is required.

U.S. Pat. No. 4,921,749 (an apparent counterpart of EP-A-0 247 898) describes a sealable boPP film having improved mechanical and optical properties. The sealability of the film and the water vapor and oxygen transmission are also improved. All improvements result from the addition of a low molecular weight resin to the base ply. The amount of resin is between 3 and 30% by weight. The resin has a molecular weight of substantially less than 5,000, preferably less than 1,000, and is, for example, 600. The softening point of the resin is 120 to 140° C.

EP-A-0 468 333 describes a sealable film having improved barrier properties with regard to the passage of water vapor and oxygen in combination with good sliding properties and low shrinkage values. The characterizing features of this boPP film are that it is composed of a base ply which comprises a polypropylene and a hydrocarbon resin having a softening point greater than 140° C., and that it has at least one sealable top, ply which, if required, additionally contains a hydrocarbon resin. The base ply and the top ply contain at least one anti-blocking agent and/or one lubricant.

In U.S. Pat. No. 4,921,749 and EP-A-0 468 333, high concentrations of hydrocarbon resin are used in order to enhance the barrier properties. Such high resin contents lead to problems in film production. In particular, resin deposits occur on the screw of the extruder and on the longitudinal stretching rolls after a short time. Owing to the high resin contents, the films have high high-temperature blocking values and exhibit a troublesome tendency to block during further processing.

A principal objective of the present invention was to provide a biaxially oriented polypropylene film which is distinguished by a high modulus of elasticity in the machine direction and enhanced barrier properties with regard to the passage of water vapor and oxygen. The disadvantages of the subsequent longitudinal stretching process, such as technical conversions in the production machine, breakdowns due to frequent tearing of the film and high residual shrinkage of the boPP films, are to be avoided. Furthermore, it must be ensured that the regenerated material can be added again in a concentration of 20 to 50% by weight, based on the total weight of the film. The film must be capable of being produced so that it runs reliably and withstands the process at production speeds of up to 400 m/min without resin deposits occurring in the preparation process. Other physical film properties which are required with regard to the use thereof as packaging film and/or as laminating film must not be adversely affected. The film should have a high gloss, no optical defects in the form of specks or bubbles, good scratch resistance, trouble-free running with low film thickness on high-speed packaging machines and, in the case of transparent film types, little opacity of the film.

### SUMMARY OF THE INVENTION

The above-described objective can be achieved by a biaxially oriented polypropylene film structure (single-ply or laminar) whose characterizing features are that the n-heptane-insoluble fraction of the film structure has a chain isotaxy index, measured by means of ¹³C-NMR spectroscopy, of at least 95% and that the base ply (in the case of a film structure having a plurality of plies) or the single ply contains essentially no hydrocarbon resin and that the modulus of elasticity of the film in the longitudinal direction is greater than 2,500 N/mm² and the modulus of elasticity of the film in the transverse direction is greater than 4,000 N/mm². Thus, the base ply (or the entire film structure, in the case of a single-ply film) is essentially free of hydrocarbon resins (whether of high softening point or low softening point) having a weight average of the molecular weight average M of substantially less than 5,000. Hydrocarbon resins are defined to be a nonhydrogenated styrene polymer, a methylstyrene/styrene copolymer, a pentadiene or cyclopentadiene copolymer, an α- or β-pinene polymer, resin or rosin derivatives or terpene polymers and hydrogenated compounds thereof or a hydrogenated α-methylstyrene/vinyltoluene copolymer or a mixture thereof.

According to the invention, the film structure can be single-ply and is then composed only of the base ply described below (in this case “base ply” is synonymous with single ply) . The base ply is defined to be that ply of the film that provides the greatest thickness. Generally the base ply is 40%, preferably 50 to 98%,, of the overall film thickness. In a preferred embodiment, the film has, on its base ply, at least one top ply or if required top plies on both sides. In a further embodiment, the film has on its base ply at least one interlayer or if required interlayers on both sides.

### BRIEF DESCRIPTION OF THE DRAWING

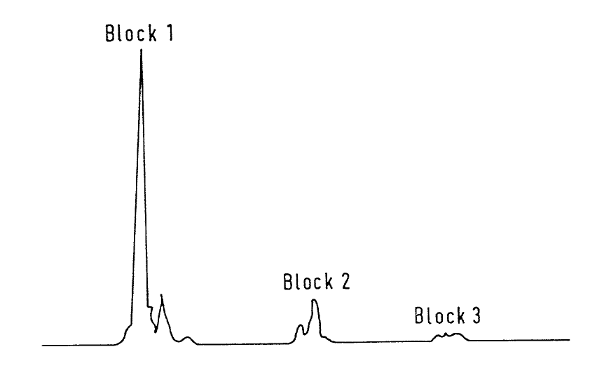

The sole Figure of the Drawing, FIG. 1, is a schematically enlarged representation of a ¹³C-NMR spectrum of an ethylene/propylene copolymer, a raw material useful in making film structures of this invention.

### DETAILED DESCRIPTION

The base ply of a film structure of this invention (or the single ply of the single-ply embodiment of the invention) contains in general at least 85% by weight, preferably 85 to 100% by weight, in particular 90 to 100% by weight, based in each case on the base or single ply (as the case may be), of a propylene homopolymer described below.

This propylene homopolymer contains at least 90% by weight, preferably 94 to 100% by weight, in particular 98 to 100% by weight, of propylene. The corresponding comonomer content of not more than 10% by weight or 0 to 6% by weight or 0 to 2% by weight, respectively, comprises, if present, in general ethylene. The data in % by weight are is based in each case on the propylene homopolymer.

The propylene homopolymer of the base ply has a melting point of 140 to 165° C., preferably 155 to 162° C., and a melt flow index (measured according to DIN 53 735 under a load of 21.6N and at 230° C.) of 1.0 to 10 g/10 min, preferably 1.5 to 6 g/10 min. The n-heptane-soluble fraction of the polymer is in general 1 to 10% by weight, based on the starting polymer. The n-heptane-insoluble fraction of the propylene homopolymer is highly isotactic. The chain isotaxy index of the n-heptane-insoluble fraction, determined by means of ¹³C-NMR spectroscopy, is at least 95%, preferably 96 to 99%.

The molecular weight distribution of the propylene homopolymer can vary within wide limits, depending on the field of use. The ratio of the weight average molecular weight M_{H} to the number average molecular weight Mₙ is in general between 2 and 15.

In a preferred embodiment of the film according to the invention, the ratio of the weight average molecular weight M_{H} to the number average molecular weight Mₙ is 2 to 6, very particularly preferably 3.5 to 5. Such a narrow molecular weight distribution of the propylene homopolymer of the base ply is achieved, for example, by peroxidic degradation thereof.

A measure of the degree of degradation of the polymer is the so-called degradation factor A, which indicates the relative change in the melt flow index according to DIN 53 735 of the polypropylene, relative to the starting polymer.

$$A = \frac{{MFI}_{2}}{{MFI}_{1}}$$

MFI₁=Melt flow index of the propylene polymer before the addition of the organic peroxide

MFI₂=Melt flow index of the propylene polymer degraded by a peroxide mechanism.

In general, the degradation factor A of the propylene polymer used is in the range from 3 to 15, preferably 6 to 10.

Dialkyl peroxides are particularly preferred as organic peroxides, an alkyl radical being understood as meaning the usual saturated straight-chain or branched lower alkyl radicals having up to six carbon atoms. 2,5-Dimethyl-2,5-di-(tert-butylperoxy)-hexane or di-tert-butyl peroxide are particularly preferred.

Furthermore, the base ply can, if desired, additionally contain conventional additives, such as antiblocking agents, neutralizing agents, stabilizers, antistatic agents, lubricants and pigments, each in effective amounts. It contains, however, essentially no resin. The term “essentially” means that a low resin content which does not influence the film properties is possible, this content being generally below 1% by weight, based on the total weight of the film.

Preferred antistatic agents are alkali metal alkane-sulfonates, polyether-modified, i.e. ethoxylated and/or propoxylated polydiorganosiloxanes (polydialkylsiloxanes, polyalkylphenylsiloxanes and the like) and/or the essentially straight-chain and saturated aliphatic, tertiary amines which have an aliphatic radical having 10 to 20 carbon atoms and are substituted by ω-hydroxy-(C₁-C₄)-alkyl groups, N,N-bis-(2-hydroxyethyl)-alkylamines having 10 to 20 carbon atoms, preferably 12 to 18 carbon atoms, in the alkyl radical being particularly suitable. The effective amount of antistatic agent is in the range from 0.05 to 0.5% by weight. Furthermore, glyceryl monostearate is preferably used as an antistatic agent, in an amount of 0.03% to 0.5%.

Suitable antiblocking agents are inorganic additives, such as silica, calcium carbonate, magnesium silicate, aluminum silicate, calcium phosphate and the like, and/or incompatible organic polymers, such as polyamides, polyesters, polycarbonates and the like, preferably benzoguanamine/formaldehyde polymers, silica and calcium carbonate. The effective amount of antiblocking agent is in the range from 0.1 to 2% by weight, preferably 0.1 to 0.8% by weight. The mean particle size is between 1 and 6 μm, in particular 2 and 5 μm, particles having a spherical shape, as described in EP-A-0 236 945 and DE-A-38 01 535, being particularly suitable.

Lubricants are higher aliphatic amides, higher aliphatic esters, waxes and metal soaps as well as polydimethylsiloxanes. The effective amount of lubricant is in the range from 0.01 to 3% by weight, preferably 0.02 to 1% by weight. The addition of higher aliphatic amides in the range from 0.01 to 0.25% by weight to the base ply is particularly suitable. A particularly suitable aliphatic amide is erucamide.

The addition of polydimethylsiloxanes in the range from 0.02 to 2.0% by weight is preferred, in particular polydimethylsiloxanes having a viscosity from 5,000 to 1,000,000 mm²/s.

The stabilizers used can be the conventional compounds having a stabilizing action for ethylene polymers, propylene polymers and other a-olefin polymers. The added amount thereof is between 0.05 and 2% by weight. Phenolic stabilizers, alkali metal stearates/alkaline earth metal stearates and/or alkali metal carbonates/alkaline earth metal carbonates are particularly suitable.

Phenolic stabilizers in an amount from 0.1 to 0.6% by weight, in particular 0.15 to 0.3% by weight, and with a molecular mass of more than 500 g/mol are preferred. Pentaerythrityl tetrakis-3-(3,5-di-tertiary-butyl-4-hydroxyphenyl)-propionate or 1,3,5-trimethyl-2,4,6-tris(3,5-di-tertiary-butyl-4-hydroxybenzyl)benzene are particularly advantageous.

Neutralizing agents are preferably dihydrotalcite, calcium stearate and/or calcium carbonate having a mean particle size of at most 0.7 μm, an absolute particle size of less than 10 Am and a specific surface area of at least 40 m²/g.

Pigments comprise those particles which essentially do not lead to vacuole formation during stretching. The coloring effect of the pigments is caused by the particles themselves. The term “pigment” is in general associated with a particle size of 0.01 to at most 1 μm and thus covers both so-called “white pigments”, which color the films white, and “colored pigments”, which impart a color to the film or render it black. In general, the mean particle diameter of the pigments is in the range from 0.01 to 1 μm, preferably 0.01 to 0.5 μm.

Conventional pigments are materials such as, for example, alumina, aluminum sulfate, barium sulfate, calcium carbonate, magnesium carbonate, silicates, such as aluminum silicate (kaolin clay) and magnesium silicate (talc), silica and titanium dioxide, among which calcium carbonate, silica and titanium dioxide are preferably used.

The base ply contains pigments in general in an amount of 1 to 25% by weight, in particular 2 to 20% by weight, preferably 5 to 15% by weight, based in each case on the base ply. Preferred pigments are white pigments, in particular TiO₂, silica and BaSO₄. These pigments preferably have a mean particle diameter of 0.01 to 0.7 μm, in particular 0.01 to 0.4 μm.

The titanium dioxide particles comprise at least 95% by weight of rutile and are preferably used with a coating of inorganic oxides, as is usually employed as a coating for TiO₂ white pigment in papers or coating materials for improving the lightfastness. The particularly suitable inorganic oxides include the oxides of aluminum, silicon, zinc or magnesium or mixtures of two or more of these compounds. They are precipitated from water-soluble compounds, for example alkali metal aluminate, in particular sodium aluminate, aluminum hydroxide, aluminum sulfate, aluminum nitrate, sodium silicate or silica, in aqueous suspension. TiO₂ particles having a coating are described, for example, in EP-A-0 078 633 and EP-A-0 044 515.

The coating also contains, if required, organic compounds having polar and nonpolar groups. Preferred organic compounds are alkanols and fatty acids having 8 to 30 carbon atoms in the alkyl group, in particular fatty acids and primary n-alkanols having 12 to 24 carbon atoms, as well as polydiorganosiloxanes and/or polyorganohydrogensiloxanes, such as polydimethylsiloxane and polymethylhydrogensiloxane.

The coating on the TiO₂ particles usually comprises 1 to 12 g, in particular 2 to 6 g, of inorganic oxides; if necessary, 0.5 to 3 g, in particular 0.7 to 1.5 g, of organic compounds, based in each case on 100 g of TiO₂ particles, are additionally present. It has proven particularly advantageous if the TiO₂ particles are coated with Al₂O₃ or with Al₂O₃ and polydimethylsiloxane.

In a preferred embodiment, the polypropylene film according to the invention comprises at least one top ply or if necessary top plies on both sides, composed of polymers of α-olefins having 2 to 10 carbon atoms. In general the top ply or both top plies contain at least 70% by weight, preferably 80 to 100% by weight, in particular 90 to 98% by weight, based in each case on each top ply, of α-olefinic polymers described below.

Examples of such α-olefinic polymers are

a propylene homopolymer or

a copolymer of

ethylene and propylene or

ethylene and 1-butylene or

propylene and 1-butylene or

a terpolymer of

ethylene and propylene and 1-butylene or

a mixture of two or more of the stated homo-, co- and terpolymers or

a blend of two or more of the stated homo-, co- and terpolymers, if necessary mixed with one or more of the stated homo-, co- and terpolymers,

in particular a propylene homopolymer or

a random ethylene/propylene copolymer having

an ethylene content of 1 to 10% by weight, preferably 2.5 to 8% by weight, or

a random propylene/1-butylene copolymer having

a butylene content of 2 to 25% by weight, preferably 4 to 20% by weight, based in each case on the total weight of the copolymer, or

a random ethylene/propylene/1-butylene terpolymer having

an ethylene content of 1 to 10% by weight, preferably 2 to 6% by weight, and

a 1-butylene content of 2 to 20% by weight, preferably 4 to 20% by weight, based in each case on the total weight of the terpolymer, or

a blend of an ethylene/propylene/1-butylene terpolymer and a propylene/1-butylene copolymer

having an ethylene content of 0.1 to 7% by weight and a propylene content of 50 to 90% by weight and a 1-butylene content of 10 to 40% by weight, based in each case on the total weight of the polymer blend,

being preferred.

The propylene homopolymer used in the top ply contains predominantly (at least 90%) propylene and has a melting point of 140° C. or higher, preferably 150 to 170° C., isotactic homopolypropylene having an n-heptane-soluble fraction of 6% by weight or less, based on the isotactic homopolypropylene, being preferred. The homopolymer has in general a melt flow index of 1.5 g/10 min to 20 g/10 min, preferably 2.0 g/10 min to 15 g/10 min.

If required, the top ply contains the propylene homopolymer which is described above for the base ply and whose n-heptane-insoluble fraction is highly isotactic. The top ply preferably essentially comprises this homopolymer.

The copolymers used in the top ply and described above have in general a melt flow index of 1.5 to 30 g/10 min, preferably 3 to 15 g/10 min. The melting point is in the range from 120 to 140° C. The terpolymers used in the top ply have a melt flow index in the range from 1.5 to 30 g/10 min, preferably 3 to 15 g/10 min, and a melting point in the range from 120 to 140° C. The blend of copolymer and terpolymer, described above, has a melt flow index of 5 to 9 g/10 min and a melting point of 120 to 150° C. All melt flow indices stated above are measured at 230° C. and under a force of 21.6N (DIN 53 735).

If required, all top ply polymers described above can be degraded by a peroxide mechanism in the manner described above for the base ply, in principle the same peroxides being used. The degradation factor for the top ply polymers is in general in a range from 3 to 15, preferably 6 to 10.

In a dull embodiment, the top ply additionally contains a high density polyethylene (HDPE) which is mixed or blended with the top ply polymers described above. The composition and details of the dull top plies are described, for example, in German Patent Application P 43 13 430.0 which is incorporated herein by reference.

If required, the additives described above for the base ply, such as antistatic agents, antiblocking agents, pigments, lubricants, neutralizing agents and stabilizers, can be added to the top ply or top plies. In a preferred embodiment, the top ply or plies contains or contain a combination of antiblocking agent, preferably SiO₂, and lubricant, preferably polydimethylsiloxane.

The film according to the invention comprises at least the base ply described above and preferably at least one top ply. Depending on its intended use, the film can have a further top ply on the opposite side, in which case the “base ply” becomes an inner ply. If required, an interlayer or interlayers can be applied on one or both sides between the base ply and the top ply or plies.

Preferred embodiments of the polypropylene film are three-ply. The structure, thickness and composition of a second top ply can be chosen independently of the top ply already present, and the second top ply can likewise contain one of the polymers or polymer mixtures which are described above but which need not be identical to that of the first top ply. The second top ply can, however, also contain other conventional top ply polymers.

The thickness of the top ply or plies is greater than 0.1 μm and is preferably in the range from 0.3 to 3 μm, in particular 0.4 to 1.5 μm, and top plies on both sides can be of equal or different thickness.

The interlayer or interlayers can comprise the α-olefinic polymers described for the top plies. In a particularly preferred embodiment, the interlayer or interlayers comprises or comprise the highly crystalline propylene homopolymer described for the base ply. The interlayer or interlayers can contain the conventional additives described for the individual plies.

The thickness of the interlayer or interlayers is greater than 0.3 μm and is preferably in the range from 1.0 to 15 μm, in particular 1.5 to 10 μm.

The total thickness of the polypropylene film structure according to the invention can vary within wide limits and depends on the intended use. It is preferably 4 to 60 μm, in particular 5 to 30 μm, preferably 6 to 25 μm, the base ply (in the case of laminar structures) accounting for about 40 to 100% of the total film thickness.

The invention furthermore relates to a process for producing a polypropylene film structure according to the invention by an extrusion process known per se; in the case of laminar structures, a coextrusion process, also known per se, is used.

In the coextrusion process, the ply or melts corresponding to the ply or to the individual plies of the film is or are coextruded through a flat die, the film thus obtained is drawn off on one or more rollers for solidification, the film is then biaxially stretched (oriented) and the biaxially stretched film is thermofixed and, if required, corona-treated or flame-treated on the surface ply intended for treatment.

The biaxial stretching (orientation) is generally carried out successively, the successive biaxial stretching, in which stretching is first carried out longitudinally (in the machine direction) and then transversely (perpendicular to the machine direction), being preferred.

Initially, the polymer or the polymer mixture of the individual plies is compressed and liquefied in an extruder, as is usual in the coextrusion process, and the additives added if required can already be present in the polymer or in the polymer mixture. The melts are then simultaneously forced through a flat die (slot die), and the extruded composite film is drawn off on one or more draw-off rollers, during which it cools and solidifies.

The film thus obtained is then stretched longitudinally and transversely relative to the extrusion direction, which leads to orientation of the molecular chains. The longitudinal stretching Us expediently carried out with the aid of two rollers running at different speeds corresponding to the desired stretching ratio, and the transverse stretching is carried out with the aid of an appropriate tenter frame. The longitudinal stretching ratios are in the range from 5.0 to 9, preferably 5.5 to 8.5. The transverse stretching ratios are in the range from 5.0 to 9.0.

The biaxial stretching of the film is followed by its thermofixing (heat treatment), the film being kept for about 0.1 to 10 s at a temperature of 100 to 160° C. The film is then wound up in the usual manner by means of a winding device.

It has proved to be particularly advantageous to keep the draw-off roller or rollers, by means of which the extruded film is cooled and solidified, at a temperature of 10 to 100° C., preferably 20 to 70° C., by a heating and cooling circulation.

The temperatures at which longitudinal and transverse stretching are carried out can be varied within a relatively wide range and depend on the desired properties of the film. In general, longitudinal stretching is preferably carried out at 80 to 150° C. and transverse stretching preferably at 120 to 170° C.

After the biaxial stretching, one or both surfaces of the film are preferably corona-treated or flame-treated by one of the known methods. The intensity of treatment is in general in the range from 37 to 50 mN/m, preferably 39 to 45 mN/m.

In an expedient corona treatment, the film is passed between two conductor elements serving as electrodes, such a high voltage, in most cases alternating voltage (about 5 to 20 kV and 5 to 30 kHz), being applied between the electrodes that spray discharges or corona discharges can take place. Due to the spray discharge or corona discharge, the air above the film surface is ionized and reacts with the molecules of the film surface so that polar spots are formed in the essentially nonpolar polymer matrix.

For a flame treatment with a polarized flame (cf. U.S. Pat. No. 4,622,237), a direct electric voltage is applied between a burner (negative pole) and a cooling roller. The level of the applied voltage is between 400 and 3,000 V, preferably in the range from 500 to 2,000 V. Owing to the applied voltage, the ionized atoms experience increased acceleration and impinge at higher kinetic energy on the polymer surface. The chemical bonds within the polymer molecule are more readily broken, and the formation of free radicals proceeds more rapidly. The thermal stress on the polymer is in this case far less than in the standard flame treatment, and films can be obtained in which the sealing properties of the treated side are even better than those of the untreated side.

The film according to the invention is distinguished by outstanding mechanical strengths.

The modulus of elasticity of the film in the longitudinal direction is greater than 2,500 N/mm², preferably greater than 2,700 N/mm², and the modulus of elasticity of the film in the transverse direction is greater than 4,000 N/mm², preferably greater than 4,200 N/mm². Surprisingly, it has been found that no resin has to be added in order to achieve these excellent moduli of elasticity in comparison with the prior art. According to the prior art, about 15 to 30% by weight of resin are added to the base ply in order to achieve the good mechanical properties. The film according to the invention contains essentially no resin with the result that no resin deposits occur on the screw of the extruder and on the rollers of the longitudinal stretching unit. Moreover, the film is distinguished by low high-temperature blocking values and by excellent, non-blocking behavior during further processing.

Surprisingly, even with a thickness of less than 20 μm, the films according to the invention are sufficiently rigid to permit processing on the modern high-speed packaging machines. With this film, it is therefore possible further to reduce the plastics content of packaging without there being any losses in the quality of the packaging.

The films are furthermore distinguished by a substantially improved barrier effect, especially with respect to water vapor and oxygen. Surprisingly, it has also been found here that, in order to achieve these good barrier values, no resin must be added to the film. In the case of the 25 μm thick film described at the outset in the prior art and having a water vapor transmission of 1.1 g/m²·d, the water vapor barrier effect can be reduced, for example, to 0.9 g/m²·d without the addition of hydrocarbon resin. In the case of films according to the prior art, the addition of at least 5 to 10% by weight of resin is required for this purpose.

The following methods of measurement were used for characterizing the raw materials and the films:

Melt Flow Index

The melt flow index was measured according to DIN 53 735 at 21.6N load and 230° C.

Melting Point

DSC measurement, maximum of the melting curve, heating rate 20° C./min.

Water Vapor and Oxygen Transmission

The water vapor transmission is determined according to DIN 53 122 Part 2. The oxygen barrier effect is determined according to Draft DIN 53 380 Part 3 at an atmospheric humidity of 53%.

Opacity

The opacity of the film was measured according to ASTM-D 1003-52.

Gloss

The gloss was determined according to DIN 67 530. The reflector value was measured as an optical characteristic of the surface of a film. Analogously to the standards ASTM-D 523-78 and ISO 2813, the angle of incidence was set at 60° or 85°. At the set angle of incidence, a light beam strikes the planar test surface and is reflected or scattered by the latter. The light beams incident on the photoelectronic receiver are indicated as a proportional electric value. The measured value is dimensionless and must be quoted with the angle of incidence.

Surface Tension

The surface tension was determined by means of the so-called ink method (DIN 53 364).

Printability

The corona-treated films were printed on 14 days after their production (short-term evaluation) or 6 months after their production (long-term evaluation). The ink adhesion was evaluated by means of the self-adhesive tape test. The ink adhesion was rated as moderate if little ink could be removed by means of self-adhesive tape and was rated as poor if a substantial amount of ink could be removed.

Tensile Strength, Elongation at Break

The tensile strength and the elongation at break are determined according to DIN 53455.

Modulus of Elasticity

The modulus of elasticity is determined according to DIN 53 457 or ASTM 882.

Determination of the High-Temperature Blocking Characteristics

To measure the high-temperature blocking characteristics, two wooden blocks adhesively bonded to felt on one side and having the dimensions 72 mm×41 mm×13 mm are wrapped and sealed in the film to be measured. A weight of 200 g is placed on the wooden blocks positioned so that the felt coverings face one another, and this set-up is introduced into a heating oven preheated to 70° C. and is left there for 2 hours. Thereafter, cooling is effected for 30 minutes to room temperature (21° C.), the weight is removed from the wooden blocks and the upper block is pulled off the lower block by means of a mechanical apparatus. The evaluation is affected over 4 individual measurements, from which a maximum pull-of f force (measured in N) is then determined. The specification is met if none of the individual measurements is above 5N.

Molecular Weight Determination

The molecular weight average M_{w} and Mₙ (weight average M_{H} and number average Mₙ) and the mean inhomogeneity of the molecular weight were determined analogously to DIN 55 672, Part 1, by means of gel permeation chromatography. Instead of THF, ortho-dichlorobenzene was used as the eluant. Since the olefinic polymers to be investigated are not soluble at room temperature, the entire measurement is carried out at an elevated temperature (≈135° C.).

Isotactic Content

Both the isotactic content of the homopolymer and the isotactic content of the film can be characterized approximately by means of the insoluble fraction of the raw material or of the film in a suitable solvent. It has proven expedient to use n-heptane. Usually, a Soxhlet extraction with boiling n-heptane is carried out. In order to obtain good reproducibility, it is expedient to fill the Soxhlet apparatus with a pellet instead of granules. The thickness of the pellet should not exceed 500 micrometers. For the quantitative determination of the atactic content of the homopolymer, it is of decisive importance to ensure sufficient extraction time. As a rule, the extraction time is in the range from 8 to 24 hours.

The operational definition of the isotactic content PPᵢₛₒ in percent is given by the ratio of the weights of the dried n-heptane-insoluble fraction to the sample weight:

PPᵢₛₒ=100×(n-heptane-insoluble fraction/sample weight)

An analysis of the dried n-heptane extract shows that, as a rule, it does not comprise pure atactic propylene homo-polymer. In the extraction, aliphatic and olefinic oligomers, in particular isotactic oligomers, and also possible additives, such as, for example, hydrogenated hydrocarbon resins, are also measured.

Chain Isotaxy Index

The isotactic content PPᵢₛₒ defined above is not sufficient for characterizing the chain isotaxy of the homopolymer. It proves to be useful to determine the chain isotaxy index II of the homopolymer by means of high-resolution ¹³C-NMR spectroscopy, the NMR sample chosen being not the original raw material but its n-heptane-insoluble fraction. To characterize the isotaxy of polymer chains, ¹³C-NMR spectroscopic triad isotaxy index II (triads) is used in practice.

Determination of the Triad-Related Chain Isotaxy Index II (Triads)

The chain isotaxy index II (triads) of the n-heptane-insoluble content of the homopolymer and of the film is determined from the ¹³C-NMR spectrum of said homopolymer or of said film. The intensities of triad signals which result from the methyl groups with different local environments are compared.

With regard to the evaluation of the ¹³C-NMR spectrum, a distinction must be made between two cases:

A) The raw material investigated is a propylene homo-polymer without a random C₂ content.

B) The raw material investigated is a propylene homopolymer having a low random C₂ content, referred to below as C₂-C₃-copolymer.

Case A

The chain isotaxy index of the homopolymer is determined from its ¹³C-NMR spectrum. The intensities of the signals which result from the methyl groups with different environments are compared. In the ¹³C-NMR spectrum of a homopolymer, essentially three groups of signals, so-called triads, occur.

1. At a chemical shift of about 21 to 22 ppm, the “mm-triad” occurs and is assigned to the methyl groups having methyl groups directly adjacent on the left and right.

2. At a chemical shift of about 20.2 to 21 ppm, the “mr-triad” occurs and is assigned to the methyl groups having methyl groups directly adjacent on the left or right.

3. At a chemical shift of about 19.3 to 20 ppm, the “rr-triad” occurs and is assigned to the methyl groups without directly adjacent methyl groups.

The intensities of the signal groups assigned are determined as the integral of the signals. The chain isotaxy index is defined as follows:

$$( triads ) = \frac{{J}_{mm} + 0.5 {J}_{mr}}{{J}_{mm} + {J}_{mr} + {J}_{rr}} \cdot 100 \qquad II$$

where Jₘₘ, Jₘᵣ and Jᵣᵣ are the integrals of the signal groups assigned.

Case B

FIG. 1 of the Drawing is a schematically enlarged representation of a ¹³C-NMR spectrum of an ethylene/propylene copolymer. The chemical shift of the methyl groups of interest is in the range from 19 to 22 ppm. As can be seen in FIG. 1, the spectrum of the methyl groups can be divided into three blocks. In these blocks, the CH₃ groups appear in triad sequences, whose assignment to the local environments is explained in detail below:

Block 1:

CH₃ groups in the PPP sequence (mm-triad)

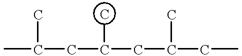

Block 2:

CH₃ groups in the PPP sequence (mr- or rm-triads)

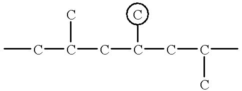

and CH₃ groups in the EPP sequence (m-chain):

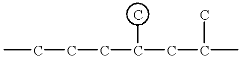

Block 3

CH₃ groups in the PPP sequence (rr-triads):

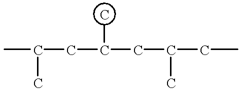

CH₃ groups in an EPP sequence (r-chain):

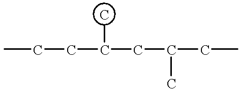

CH₃ group s in an EPE sequence:

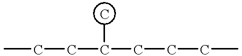

In the determination of the triad-related chain isotaxy index II (triads) of the n-heptane-insoluble content of an ethylene/propylene copolymer, only PPP triads were considered, i.e. only those propylene units which are present between two adjacent propylene units (cf. also EP-B-0 115 940, page 3, lines 48 and 49).

The definition of the triad isotaxy index of an ethylene/propylene copolymer is:

II (triads)=100×(Jₘₘ/Jₚₚₚ)

Calculation of the chain isotaxy index of an ethylene/propylene copolymer:

1. Jₘₘ is given by the peak integral of block 1.

2. Calculate the integral (Jₜₒₜₐₗ) of all methyl group peaks in blocks 1, 2 and 3.

3. By simple considerations, it is possible to show that Jₚₚₚ=Jₜₒₜₐₗ−J_{EPP}−J_{EPE}.

Sample Preparation and Measurement

60 to 100 mg of polypropylene are weighed into a 10 mm NMR tube and hexachlorobutadiene and tetrachloroethane are added in a ratio of about 1.5:1 until a level of about 45 mm is reached. The suspension is kept at about 140° C. until (as a rule about one hour) a homogeneous solution has formed. In order to accelerate the dissolution process, the sample is stirred from time to time with a glass rod.

The ¹³C-NMR spectrum is recorded at an elevated temperature (as a rule 365K) under standard measuring conditions (semiquantitatively).

The following Examples illustrate the principles and the practice of this invention without in any way limiting its scope.

### EXAMPLE 1

A transparent three-ply film having a symmetrical structure and a total thickness of 16 μm was produced by coextrusion and subsequent stepwise orientation in the longitudinal and transverse direction. The top plies each had a thickness of 0.6 μm.

A-base ply:

99.85% by weight of highly isotactic polypropylene from Solvay, having the brand name Eltex P HCL 480

0.15% by weight of N,N-bisethoxyalkylamine

The n-heptane-insoluble fraction of the film had a chain isotaxy index of 96%, measured by means of ¹³C-NMR spectroscopy.

B-top plies:

98.77% by weight of a random ethylene/propylene copolymer having a C₂ content of 4.5% by weight

0.33% by weight of SiO₂ as an antiblocking agent, having a mean particle size of 2 μm

0.90% by weight of polydimethylsiloxane having a viscosity of 30,000 mm²/s

The production conditions in the individual process steps were:

| | | | |
|---|---|---|---|
| Extrusion: | Temperatures | A-ply: | 280° C. |
| | | B-plies: | 280° C. |

| | | |
|---|---|---|
| | Temperature of the draw-off | 30° C. |
| | roller: | |
| Longitudinal | Temperature: | 135° C. |
| stretching: | Longitudinal stretching ratio: | 6.5 |
| Transverse | Temperature: | 160° C. |
| stretching: | Transverse stretching ratio: | 8.5 |
| Fixing: | Temperature: | 110° C. |
| | convergence: | 20% |

The transverse stretching ratio λ_{T}=8.5 is an effective value. This effective value is calculated from the final film width W, minus twice the seam width w, divided by the width of the longitudinally stretched film C, likewise minus twice the seam width w.

| | | |
|---|---|---|
| Numerical data: | Final film width | W = 4,000 mm |
| | Final film thickness | d = 16 μm |
| | Seam width | w = 40 mm |
| | Width of the longitu- | C = 530 mm |
| | dinally stretched film | |

The film produced in this manner had the properties listed in the Table (first line: Example 1).

### EXAMPLE 2

A three-ply film having a total thickness of 16 μm and top ply thicknesses of 0.5 μm each was produced as in Example 1. The raw material composition for the base ply and for the top plies is also the same as in Example 1. Only the conditions during longitudinal and transverse stretching were changed:

| | | |
|---|---|---|
| Longitudinal stretching: | Temperature: | 135° C. |
| | Longitudinal stretching | 7.5 |
| | ratio: | |
| Transverse stretching: | Temperature: | 160° C. |
| | Transverse stretching | 8.0 |
| | ratio: | |

The film properties are listed in the Table—second line (Example 2).

### EXAMPLE 3

The formulation for the base ply was chosen as in Example 1. In the case of the top plies, the siloxane content was increased from 0.9% by weight to 1.6% by weight. The slip capacity of the film was thus considerably improved. The process conditions were those from Example 2.

### EXAMPLE 4

The formulation of Example 2 was used for the base ply. In addition, the base ply also contained erucamide as a lubricant in a concentration of 0.2% by weight, based on the base ply. The top plies likewise contained the highly isotactic polypropylene from Solvay. The silica from Example 1 was used in the same concentration as an antiblocking agent in the top plies. The process parameters were taken from Example 2.

### EXAMPLE 5

The thickness of the base ply was retained. The top ply thicknesses were each 1 μm. The base ply corresponded to that of Example 1. The top plies were symmetrically arranged as in Example 1 and had the following formulation:

68.77% by weight of a random ethylene/propylene copolymer having a C₂ content of 4.6% by weight

30.0% by weight of low density polyethylene having a melt flow index of 2 g/10 min from Hoechst, with the brand name HOSTALEN GD 7255

0.33% by weight of SiO₂ as an antiblocking agent, having a mean particle size of 2 μm

0.90% by weight of polydimethylsiloxane having a viscosity of 30,000 mm²/s

The production conditions in the individual process steps were as stated in Example 1.

In comparison with the previous Examples, the film had a dull appearance.

### EXAMPLE 6

The formulation of the film was as in Example 1. The stretching conditions were taken from Example 1. The film thickness was now 20 μm instead of 16 μm.

### Comparative Example 1

With regard to the thicknesses, the film structure and the process conditions, there were no changes compared with Example 1. Instead of the material from Solvay (Eltex P HCL 480) used in the base ply, the material from Solvay, Eltex PHP 405, known from the prior art, was now chosen. The n-heptane-insoluble fraction of the film had a chain isotaxy index, measured by means of ¹³C-NMR spectroscopy, of 92%. The resulting film properties are listed in the Table.

### Comparative Example 2

Example 1 described in EP-A-0 046 833 was worked through. The n-heptane-soluble fraction of the film had a chain isotaxy index, measured by means of ¹³C-NMR spectroscopy, of 93%. The resin content in the base ply was 10% by weight. In comparison with the film according to the invention (cf. Example 6), the barrier values for water vapor and the tensile modulus of elasticity are substantially lower.

As used in this application, the terms “polypropylene” and “propylene polymer” refer to both homopolymers and copolymers (including terpolymers, quaterpolymers, etc.) of propylene.

TABLE

| | | Modulus of | Tensile | Elongation | | | | Friction | | High- |
|---|---|---|---|---|---|---|---|---|---|---|
| | | elasticity | strength | at break | | Water vapor | Opacity | 14 days | | temperature |
| | | DIN 53 457 | DIN 53 455 | DIN 53 455 | | trans- | ASTM | after | | blocking |
| | Film | longitudinal/ | longitudinal/ | longitudinal/ | | mission | D | production | Scratch | character- |
| | thickness | transverse | transverse | transverse | Gloss | DIN 53 122 | 1003-52 | B side/ | resistance | istics |
| | μm | N/mm² | N/mm² | % | DIN 67 530 | g/m² · d | % | B′ side | Δ opacity | N |
| E1 | 16 | 2800/4100 | 200/230 | 140/70 | 100 | 1.4 | 2.0 | 0.23/0.25 | 25 | 1.5 |
| E2 | 16 | 3000/4250 | 200/250 | 120/70 | 100 | 1.4 | 2.0 | 0.25/0.25 | 25 | 1.0 |
| E3 | 16 | 3100/4300 | 200/270 | 120/70 | 100 | 1.4 | 2.0 | 0.20/0.20 | 25 | 1.5 |
| E4 | 16 | 3300/4400 | 220/280 | 110/70 | 105 | 1.4 | 1.0 | 0.24/0.25 | 10 | — |
| ES | 16 | 2700/4050 | 190/240 | 140/70 | 20 | 1.45 | 40 | 0.20/0.20 | 35 | 0.5 |
| E6 | 16 | 2800/4100 | 200/240 | 140/70 | 105 | 1.1 | 2.0 | 0.25/0.27 | 25 | 1.3 |
| CE1 | 16 | 2300/4100 | 150/320 | 160/70 | 100 | 1.8 | 2.0 | 0.23/0.25 | 25 | 3.0 |
| CE2 | 20 | 2200/4200 | 140/320 | 155/65 | 100 | 0.88 | 2.0 | 0.24/0.27 | 27 | 7.0 |

E = Example; CE = Comparative Example;
B side: top Layer in contact with the chill roll;
B′ side; top layer which may be corona- or flame treated if required

What is claimed is:

1. A biaxially oriented polypropylene film structure comprising at least one propylene polymer-containing ply, said film structure having:
an n-heptane-insoluble fraction which has a chain isotaxy index, measured by means of ¹³C-NMR spectroscopy, of at least 95%,
a modulus of elasticity of the film structure in the longitudinal direction which is greater than 2,500 N/mm² and a modulus of elasticity of the film structure in the transverse direction which is greater than 4,000 N/mm²,
said propylene polymer-containing ply being essentially free of hydrocarbon resin having a weight average of the molecular weight average M_{w} less than 5,000.

2. The polypropylene film structure as claimed in claim 1, wherein said film structure comprises a plurality of plies, and said propylene polymer-containing ply is the base ply of said film structure.

3. The polypropylene film structure as claimed in claim 1, wherein the water vapor transmission, WVT, of the film structure, as defined in accordance with German Engineering Standard DIN 53 122 obeys the formula
$$WVT \leq \frac{C}{d}$$
where d is the thickness of the film in μm and C is 22.5 g·μm/m².

4. The polypropylene film structure as claimed in claim 1, wherein the modulus of elasticity of the film structure in the longitudinal direction is greater than 2,700 N/mm² and the modulus of elasticity of the film structure in the transverse direction is greater than 4,200 N/mm².

5. The polypropylene film structure as claimed in claim 1, wherein the tensile strength of said film structure in the longitudinal direction is greater than 160 N/mm² and that in the transverse direction is greater than 230 N/mm², and the elongation at break in the longitudinal direction is less than 140% and that in the transverse direction is greater than 60%.

6. The polypropylene film structure as claimed in claim 2, wherein said base ply contains a polypropylene whose n-heptane-insoluble fraction has a chain isotaxy index, measured by means of ¹³C-NMR spectroscopy, of at least 95%.

7. The polypropylene film structure as claimed in claim 2, wherein said base ply contains a polypropylene whose M_{w}/Mₙ is greater than 6.

8. The polypropylene film structure as claimed in claim 2, wherein the propylene polymer of said base ply has been degraded by a peroxide mechanism and the M_{w}/Mₙ of said propylene polymer is less than 6.

9. The polypropylene film structure as claimed in claim 8, wherein the degradation factor resulting from degradation by a said peroxide mechanism is 3 to 15.

10. The polypropylene film structure as claimed in claim 2, which has a top ply comprising α-olefinic polymers on at least one side.

11. The polypropylene film structure as claimed in claim 10, wherein the top ply or plies contains or contain a propylene homopolymer whose n-heptane-insoluble fraction has a chain isotaxy index, measured by means of ¹³C-NMR spectroscopy, of at least 95%.

12. The polypropylene film structure as claimed in claim 10, wherein the polymer of the top ply or plies is degraded by a peroxide mechanism and the degradation factor is in the range from 3 to 15.

13. The polypropylene film structure as claimed in claim 2, comprising a said base ply and at least one top ply, wherein interlayer or interlayers on one or both sides and comprising α-olefinic polymers is or are applied between the base ply and the top ply or plies.

14. The polypropylene film structure as claimed in claim 2, comprising a said base ply and at least one interlayer, wherein the interlayer or interlayers contains or contain a propylene homopolymer whose n-heptane-insoluble fraction has a chain isotaxy index, measured by means of ¹³C-NMR spectroscopy, of at least 95%.

15. The polypropylene film structure as claimed in claim 2, comprising a said base ply and at least one interlayer, wherein a polymer of the interlayer or interlayers has been degraded by a peroxide mechanism, and the degradation factor is in the range from 3 to 15.

16. The polypropylene film structure as claimed in claim 2, comprising a said base ply and at least one interlayer, wherein a said interlayer contains a pigment.

17. The polypropylene film structure as claimed in claim 2, wherein said base ply contains an antistatic agent.

18. The polypropylene film structure as claimed in claim 2, wherein said base ply contains a pigment.

19. The polypropylene film structure as claimed in claim 2, comprising a said base ply and at least one top ply, wherein a said top ply contains a lubricant and an antiblocking agent.

20. The polypropylene film structure as claimed in claim 2, comprising a said base ply and at least one interlayer, wherein a said interlayer contains a neutralizing agent, a stabilizer, an antistatic agent an anti-blocking agent, or a combination thereof.

21. The polypropylene film structure as claimed in claim 2, comprising a said base ply and at least one top ply, wherein a said top ply is sealable.

22. The polypropylene film structure as claimed in claim 2, comprising a said base ply and at least one top ply, wherein a said top ply is not sealable.

23. The polypropylene film structure as claimed in claim 2, wherein the thickness of the film structure ranges from 4 to 60 μm, said base ply accounting for about 40 to 60% of the total thickness.

24. The polypropylene film structure as claimed in claim 1, wherein said film structure is a single-ply film.

25. A process for the production of a polypropylene film structure as claimed in claim 1, wherein the orientation in the longitudinal direction is effected with a longitudinal stretching ratio of 5:1 to 9:1 and that in the transverse direction is effected with a transverse stretching ratio of 5:1 to 9:1.

26. A method of packaging comprising the step of packaging the material or object to be packaged in a packaging film comprising the film structure as claimed in claim 1.

27. An enclosed package comprising a polypropylene film structure as claimed in claim 1.
